(19) United States
(12) Patent Application Publication
(10) Pub. No.: US 2006/0143222 A1
(43) Pub. Date: Jun. 29, 2006

(54) Method, program and system for automatic reengineering of a client code

(76) Inventor: Maxime Daniel, Besne (FR)

Correspondence Address: IBM CORPORATION;INTELLECTUAL PROPERTY LAW, 11400 BURNET ROAD, AUSTIN, TX, 78758, US

(21) Appl. No.: 11/260,556

(22) Filed: Oct. 27, 2005

(30) Foreign Application Priority Data
Dec. 23, 2004 (EP) 04300949.7

(51) Int. Cl. G06F 17/00; G06F 7/00

(52) U.S. Cl. 707/102

(57) ABSTRACT

A method, program and system for automatic reengineering of an input client code using an API when an API adapter code, is provided for emulating an old version of the API on a new version of the API, wherein the items no more provided in new API are identified, said method comprising the steps of parsing (200) the API adapter source code into a memory representation of this code; building (210) an index of the items of the API adapter code memory representation which have been identified; generating (220) a parametrized code memory representation of replacement code for the calls to the identified items; parsing (230) the input client code into a memory representation of this code; searching (240) in the memory representation of the input client code the calls to an identified item and reading the corresponding call parameters; replacing (260) the calls by the code memory representation of replacement code using the call parameters read in the preceding step; and, generating (270) the code corresponding to the memory representation of the input client code wherein the calls have been replaced.

### FIELD OF THE INVENTION

The present invention generally relates to the reenginering of application programs. More particularly, the present invention relates to the maintenance of application programs using a new version of an existing API.

### BACKGROUND OF THE INVENTION

Code libraries and frameworks privers change their code ever faster. Their client has to reengineer his own application code at each change of the provider code. Typically, a sizable part of base Java (Java is a trademark of Sun Microsystems Incorporation in certain countries) APIs change with every major release of the Java Developer Kit, every two years or more often. Even more significantly, most lines of products need to undergo periodical migrations at client sites where heavy code-based customization occurs on client applications on a regular basis.

The negative impact on the programmers who use the APIs (client programmers) is that sooner or later, they need to migrate their code so that it runs over the newest versions of base APIS. Such migrations implies the following pain points:

these migrations are expensive: according to the tenets of code reuse, the code using the APIs should be much more voluminous than the code that implements the API—at least on a global basis—and migration costs raise with volumes;

—these migrations raise extra risks, especially the risk that code modifications induced by migration needs exhibit side effects on the system behavior; more bluntly said: the client programmers break their code because of changes induced by others, while according to the encapsulation principle, it should be the responsibility of the programmers who provide the APIS (API programmers) to ensure the upward compatibility and the continued value over time of the API, not the one of the client programmers.

The impact on provider API programmers is dual:

the provider API programmers need to provide reasonable migration help to the client programmers, at extra cost above the one of the API development per se;

the provider API programmers are compelled to twist the design of some desired changes or to select them out altogether for the sake of upward compatibility.

Difficulties only raise higher when APIs stack up: API programmers who provide higher level APIs built upon lower level ones must cope with all the issues described above.

One can note that the reason why the provider modifies his API code despite such costs and pain points is most often the very desire or even need to deliver superior value in the newest versions of APIs. In other words, APIs' changes do happen—whatever it may cost to the industry. This invention specifically aims at alleviating the negative side effects of such changes.

In the realm of high-level compiled programming languages (including C, C++, Pascal and semi-interpreted Object-Oriented languages such as Java), partial solutions to the considered problem exist today. Four are described hereunder in growing level of sophistication:

the first existing solution (S1) consists in helping the client to identify the parts of his application code that need to be modified according to the new API. The client uses the compiler or the linker for API compatibility checks. While this is only a very basic help in the matter, it at least catches unnoticed changes in the API make up—some of which typically go undetected when using assembly languages. The main drawbacks of that solution is that the client code needs to be modified so as to implement calls to the latest API. The developer benefits from minimal assistance to do so (compiler errors point her to places that need to be modified, with no indication about how the modification should be undertaken.) The volume of the needed changes is most often important. These two effects combine into a very error prone, risky process. Moreover, the system comprised of the initial client code and the new API does not compile at all, which precludes any iterative attempt to fix the client code (iterative processes are often leveraged to minimize risks.)

the second existing solution (S2) consists for the API code provider to deliver an API adapter that enable the client application programmers of the older version API to leave their code as it is while calling the newer version of the API under the cover. The problem here is that adaptation layers stay in the system in the medium term, affecting severely the performance, understandability and maintainability of the whole system. This solution generates low or no incentive for the developer of the client code to migrate it to the newer API. Accordingly, the resulting system may perpetuate, the initial client code remaining unchanged forever, and the adaptation layers staying in the system as well. Last but not least, the after facts removal of adaptation layers can prove difficult, especially in programming languages for which they would not match the boundaries of a distinct building part of the system. (Building parts would be a class or jar file in Java, an object of lib file in C or C++, etc.)

the third existing solution (S3) consists in refinements of the latter (S2) that help users of the older version API to pinpoint areas in their code that should be migrated as soon as possible. The ‘deprecated’ directive of the Java language is the best example of such a technique. This merely delays the refactoring needs, in effect bridging the gap for the lifetime of one or two intermediate versions. This solution shares with S2 its main drawbacks, with a few mitigation. The client code developer is a little bit more encouraged to migrate her code, and benefits from some help to undertake that task. Nevertheless, the client code migration is still a manual process, the adaptation layers remain in the system for a while, and their removal is not much helped compared to S2.

the fourth existing solution (S4) is more and more used today. It corresponds to the latest developments in interactive refactoring tools delivered by third parties. The client first makes some API changes in the libraries of the API code and then uses the refactoring tool to propagate the said changes in all places where this is needed in the developer's current application development environment (so called Integrated Development Environments, IDEs) files. Integrated Development Environments have made considerable inroads into the refactoring tooling domain, somewhat mitigating refactoring costs. But the odds of errors made by the client programmer are still high, the volume of the changes can still be considerable compared to the API implementation size, and the responsibility of such errors is still the one of the wrong person (the client programmers instead of the API programmers). The manual application of refactoring tools, how useful as each of them may be, lack of a clear orchestration. The number of steps that must be taken by client code developers raises sharply with the number of changes between the older and the newer APIs and is commensurate to the number of elementary changes. This solution works at its best when the same developer can operate simultaneously on the complete source code of the system (that is, the developer has control on all parts including the older and the newer versions of the libraries), and an iterative approach is practical. (For example, the client developer modifies a Java method name and lets the refactoring tool operate the name change in all places where this is needed in the developer's current development environment files.) Three main drawbacks remain yet:
if the client code developer does not have the older library source at hand, she cannot anchor the renaming operation; hence, if the developers of libraries on the one hand and client code on the other hand work for separate organizations and have no contract in place to share source code, the refactoring tools are difficult to leverage; (a solution would be that the client code developer writes a mock library code to anchor the refactoring, which can prove difficult or expensive;)
if the client code developer does not or cannot get the whole client code in a single workspace, the migration is partial, and the integration of separately migrated fragments into the new version of the client code can prove difficult and risky; conversely, if the client code is large and the developer migrates it in a single workbench, the refactoring tools performances tend to degrade, and the migration session becomes uncomfortable, long period of waiting being interspersed with short interactions with the tooling; (contrast this with a single batch operation that, after a while, delivers a complete new version of the client code in a single pass);
the migration process must be executed by each organization or group that owns a client code asset; while the present invention does not remove this need, it proposes that each client executes a command against the existing code, whereas S4 commands that a potentially long series of itemized refactoring operations be performed by a human operator.

The common limits of those existing solutions (S1, S2, S3, S4) is that the burden of fixing the code eventually remains on the client programmers, and that either extra code remains in the system (S2, S3), or the client programmer has to invest quite a lot in code refactoring (S1, S4).

### SUMMARY OF THE INVENTION

It is therefore an object of the present invention to provide a method for automatically generating the new client application code using a new API code delivered by the API code provider.

The object is reached, according to claim 1, with a method for automatic reengineering of an input client code using an API when an API adapter code is provided for emulating an old version of the API on a new version of the API, wherein the items no more provided in new API are identified, said method comprising the steps of:

parsing (200) the API adapter source code into a memory representation of this code;

building (210) an index of the items of the API adapter code memory representation which have been identified;

generating (220) a parametrized code memory representation of replacement code for the calls to the identified items;

parsing (230) the input client code into a memory representation of this code;

searching (240) in the memory representation of the input client code the calls to an identified item and reading the corresponding call parameters;

replacing (260) the calls by the code memory representation of replacement code using the call parameters read in the preceding step;

generating (270) the code corresponding to the memory representation of the input client code wherein the calls have been replaced.

The object is also reached, according to claim 2, with the method of claim 1 further comprising an initial step of:

compiling the API adapter source code into a binary representation of this code;

wherein the step of parsing (200) the API adapter source code is replaced by a step of:

loading the binary code into a memory representation of this code;

The object is also reached, according to claim 3, with the method of claim 1 or claim 2 further comprising between execution of the step for generating (220) a parametrized code memory representation of replacement code for the calls to the identified items, and the step of parsing (230) the input client code into a memory representation of this code, the step of:

searching in the memory representation of the API adapter source code and in the generated parametrized code memory representation of replacement code for the calls to the identified items, the calls to an identified item and reading the corresponding call parameters;

replacing the just searched calls by the code memory representation of replacement code using the call parameters read in the preceding step.

The object is also reached, according to claim 4, with the method of anyone of claims 1 to 3 wherein in the steps the memory representation are abstract syntax trees, the items are tree nodes and a symbol table is used for indexed items.

The object is also reached, according to claim 5, with the method of anyone of claims 1 to 3 wherein in the steps the memory representation are tables, the items are table records and a symbol table is used for indexed items.

The object is also reached, according to claim 6, with the method of anyone of claims 1 to 3 wherein in the steps the memory representation are acyclic directed graphs, the items are nodes in the graphs and a symbol table is used for indexed items.

The object is also reached, according to claim 7, with the method of anyone of claims 1 to 6 wherein the input and generated client codes, the API adapter code are written in the same programming language.

The object is also reached, according to claim 8, with the method of claim 7 wherein the said programming language is Java or C or C++ or Pascal.

The object is also reached, according to claim 9, with a computer program product comprising programming code instructions for executing the steps of the method according to anyone of claims 1 to 8 when said program is executed on a computer.

The object is also reached, according to claim 10, with a system comprising means adapted for carrying out the method according to anyone of claims 1 to 9.

The solution of the present invention can work only if the API provider delivers an API adapter with his new API. This is often the case. The major interest of the solution of the present invention is to use as input to the transformation engine the API adapter which is used today as an intermediate emulation layer to the new API allowing the old client application to use the new API without changing his application code.

Some advantages of the solution of the present invention extending beyond the object of the invention are as follows:

The invariance of the function provided by the complete system (client code plus libraries) relies on the provider programmers (who are responsible for the initial change in the system).

The migration is as reliable as the code transformation engine and the API adapters are. Since API adapters are normally much smaller than the cumulated client code (possibly spanning many applications), the provider programmers can afford to spend more on its quality. Hence, the resulting quality of the migrated systems is higher.

The design of the new library is constrained by the invention, in that only changes for which an automatically removable API adapter can be coded are admissible. By construction, this warranties that the new library will not deliver less value than the old library. This has to be contrasted with S2 and S3 above, for which the after facts removal of API adapters can lead to the late discovery of ascending compatibility breakage. Moreover, this guides the provider programmer throughout the elaboration of the new library with very concrete indication of which changes are permitted and which are not.

The new library code is optimized, in that no adapter code remains in the final system.

This optimization is operated automatically, whereas it can prove difficult when the compilation units boundaries of the considered programming language do not match cleanly the API adapters description (typically, the deprecated directive of the Java language decorates a method description, which is only a subpart of a class, for which a file is the compilation unit).

The new library code is easier to understand, because all migration related code is confined into the API adapters.

All test code developed by the provider programmers to ensure that the old library delivers what is expected, can be reused by the same programmers to test API adapters are correct (like with S2 and S3) as usually done. Beyond this, it can also be automatically migrated to initialize the test code for the new library (using the invention to migrate the test code, seen as a specific instance of client code). For organizations that have strong quality assurance policies in place, the volume of test code can be heavy compared to the volume of the libraries, hence the benefit of migrating test code at low cost is important.

### BRIEF DESCRIPTION OF THE DRAWINGS

FIG. 1 illustrates the context of execution of the engine transforming the application source code of the client into a new source code using the new API;

FIG. 2 is the general flow chart of the method according to the preferred embodiment;

FIG. 3 illustrates the context of execution in Java like language of an additional engine, EL, which extracts the new API code from the new provider API libraries mixed into a same compilation unit with the API adapter;

FIG. 4 illustrates the context of execution of another embodiment of the invention when the provider delivers an API adapter in binary code instead of source code.

### DETAILED DESCRIPTION OF THE PREFERRED EMBODIMENT

The method of the preferred embodiment can be implemented as a program which could be delivered by the API code provider but also developed by the client himself or by a third party, which transforms the client application code using a certain provider API, into a new application code using the new version of the API delivered by the API code provider. The transformation program can be executed on the client site by a client operator. The inputs of the transformation are the client application code and the source code of an API adapter that implements the old version of the API upon the new version of the API. The output of the transformation is a new version of the client application code that uses only the new version of the API. The transformation program is specific to the programming language of the client application and the API code. The transformation program of the solution of the preferred embodiment operates on a workstation able to execute programs in the language of the transformation program.

The figures described hereunder use a logic representation of code which is valid for any type of language. In the figures a code component is represented as the combination of a function and an implementation. In some languages such as Java the function is typically provided as a HTML file and the implementation as a binary code. For other languages such as C or C++ the function is typically delivered as a source code in header files and the implementation as a binary code. While the considered programming language implies constraints on the possible deliveries, several choices generally exist that may be further refined under non technical constraints. Especially, all programming languages accommodate a configuration in which all components are delivered as source code in their entirety, but sharing source code amongst organizations may not be an option in some circumstances. The transformation program of the solution of the preferred embodiment is represented as the E (150) engine.

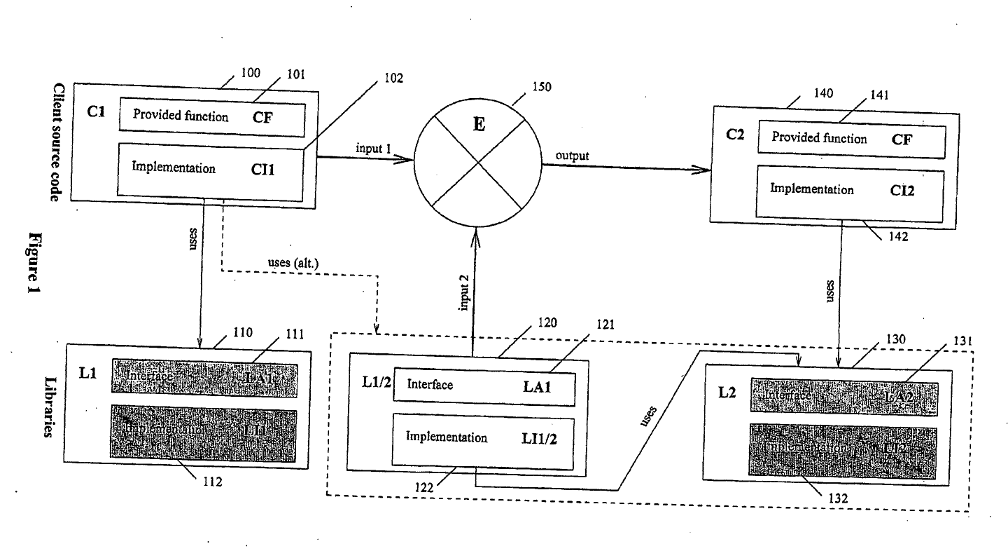

FIG. 1 illustrates the context of execution of the engine transforming the application source code of the client into a new source code using the new API. In FIG. 1, The client code C1 (100) provides end users (or higher code in the stack) the CF function (101), by means of the CI1 implementation (102).

The L1 (110), L1/2 (120) and L2 (130) libraries provide some functions to client code. Those functions are described by application programming interfaces, respectively LA1 (111) for L1, LA1 (121) for L1/2, and LA2 (131) for L2. The 111 and 121 interfaces are semantically identical, hence their common LA1 name, even if they may be implemented as two distinct copies of the same source code. L1 (110), L1/2 (120) and L2 (130) provide their respective functions by means of implementations, respectively LI1 (112), LI1/2 (122) and LI2 (132).

LI1/2 (120) is implemented upon L2 (130), and does not depend on L1 (110) at all.

CI1 (102) is implemented upon L1 (110).

C1 (100) can deliver its function by being compiled then linked with L1 (110), or by being compiled then linked with L1/2 (120) and L2 (130).

C1 (100) and L1/2 (120) are fully described in source code.

LA1 (111) and LA2 (131) may be provided as source code, or in a human readable form that enables programmers to produce C1 (100) and L1/2 (120) (or any other client code that uses L1 or L2).

LI1 (112) and LI2 (132) may be provided either as source code, or as compiled or semi compiled code.

The output of the code transformation engine E (150), is the C2 (140) client code. It provides to end users (or higher code in the stack) the same CF function (141) as C1 (100), by means of the CI2 implementation (142). The 101 and 141 functions are semantically identical, hence their common CF name. CI2 (142) is implemented upon L2 (130) and does not depend on L1 (110). C2 (140) can deliver its function by being compiled then linked with L2 (140) alone, that is without L1/2 (120) or L1 (110).

The code transformation engine E (150) automatically produces C2 (140) from C1 (100) and L1/2 (120), which constitutes the core of the present invention.

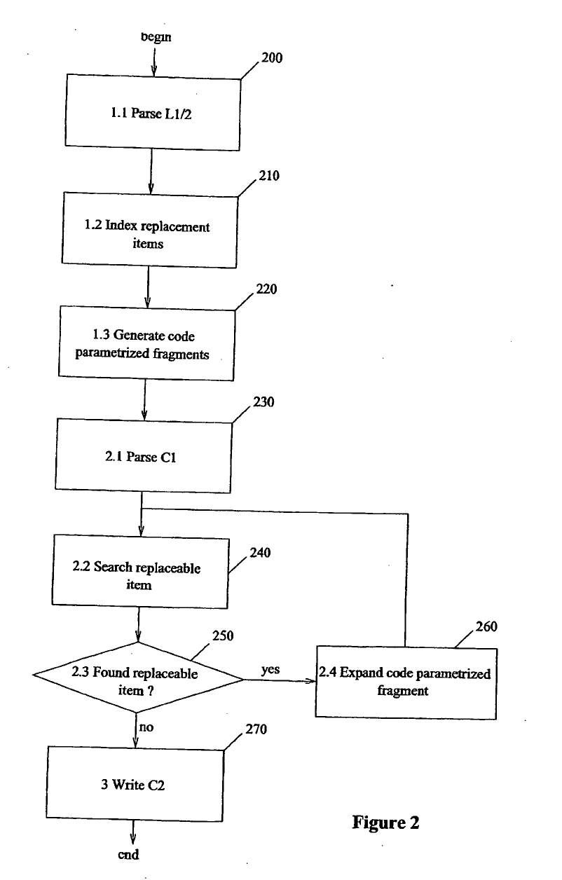

FIG. 2 is the general flow chart of the method according to the preferred embodiment. It illustrates the canonical transformation process operated by the transformation engine E (150). Variations to this embodiment are illustrated by other figures described later in the document.

A code example is given hereunder, which in the context of the C programming language, shows the concrete results on the source code of a possible embodiment of the invention. This example is meant to support the invention description. The invention is expected to cover several programming languages beyond this example.

In the code example, the interface of the libraries is defined as follows:

// LA1 (111):
extern int oldName (int parameter);
// LA2 (131):
extern int newName (int parameter);

The process begins with C1 (100), or any subpart of C1 that constitutes a compilation unit for the considered programming language, and L1/2 (120) as inputs.

```
// C1 (100):
void main ( ) {
  exit(oldName(5));
}
// L1/2 (120)
int oldName (int parameter)
/* REPLACE */
{
  return newName(parameter);
}
```

Step 1.1 (200) parses L1/2 (120) into a memory structure that has the following characteristics:

it includes a decorated abstract syntax tree of the L1/2 source code;

it includes symbol tables and other elements so that the combination of them and the abstract syntax tree constitute a complete representation of L1/2 given the semantics of the considered programming language.

It is noted that such in memory representations of programs are commonplace, since they are one pivotal element of compilers. The in memory representations of programs may be implemented as abstract syntax trees, the items being tree nodes and a symbol table being used for indexed items. One other suitable in memory representations of programs may be an acyclic directed graph, the items being nodes in the graphs and a symbol table being used for indexed items. One other suitable in memory representation of programs may be also tables, the items being table records and a symbol table being used for indexed items.

Step 1.2 (210) searches the in memory representation produced by step 1.1 (200), so as to identify and index all items of LA1 (121) that have to be replaced by calls to LA2 (131). In a possible embodiment of the invention, the matching items are exactly those that bear in their comments the ‘REPLACE’ mark, as shown in the code example.

Step 1.3 (220) generates a parametrized code fragment for each of the indexed replacement items. Note that this fragment uses an in memory representation that extends the one obtained in step 1.1 (200) with capabilities that are specific to the invention, beyond the capabilities normally implemented in compilers. A possible text based representation of such an in memory representation for the example described sooner would be:

```
// Code parametrized fragment for oldName (illustrative)
  {
    int _result_01;
    {
      int _parameter_01;
      _parameter_01 = <<parameter value>>;
      _result_01 = newName(_parameter_01);
    }
    <<statement(_result_01)>>
  }
(Note that this one is not a correct C language fragment.)
```

The elaboration of such fragments is defined by the language semantics. In the code example, the (seemingly extraneous) expansion of the function parameter into the intermediate _parameter_{—}01 local variable warranties that the exact C language parameter passing rules will be applied to the concrete parameter passed to oldName in C1 (100).

Step 2.1 (230) parses C1 (100), or a subset of C1 that constitutes a compiling unit, into an in memory structure like the one elaborated in step 1.1 (200).

Step 2.2 (240) searches into the in memory structure elaborated in step 2.1 (230) a replacement item indexed in step 1.2 (210). In the example below, the C1 (100) call to oldname in function main matches the oldName replacement item of L1/2 (120).

Step 2.3 (250) performs a test and branch operation as follows:

If no (new) replacement item matches, proceed to step 3 (270). Else, proceed to step 2.4 (260).

Step 2.4 (260) replaces into the in memory structure obtained in step 2.1 (230) the matched item by the expansion of the code parametrized fragment obtained in step 1.3 (220) for the considered item.

Then, step 2.2 (240) is performed again.

Step 3 (270) generates the text code corresponding to the (modified) in memory structure obtained by the (repeated) application of steps 2.2 (240) and 2.4 (260). The result would be:

```
// C2 (140):
void main ( ) {
  {
    int _result_01;
    {
      int _parameter_01;
      _parameter_01 = 5;
      _result_01 = newName(_parameter_01);
    }
    exit(_result_01);
  }
}
```

The considerations exposed above are targeted at the simplest possible embodiment of the invention: replace function (or method) calls by the code expansion of their definition. The following sections give further insight into what could be considered as advanced applications.

Optionally, the engine can further perform a decoration of the resulting code in order to help the client programmer to refine the migration. The step of expanding code parametrized fragments (260) is modified to memorize which code fragment is an expanded code. Then the step of code creation (270) is modified to include automatic marking of the resulting code with specific markers (in comments), for instance before and after code expansion.

Example:

```
// C2 (140):
void main ( ) {
  /* TODO BEGIN REFACTORING */
  {
    int _result_01;
    {
      int _parameter_01;
      _parameter_01 = 5;
      _result_01 = newName(_parameter_01);
    }
    exit(_result_01);
  }
  /* END REFACTORING */
}
```

Optionally, the code parametrized fragments generation (220) can be optimize the fragments. The canonical parametrized fragments (step 220) can be refined in some circumstances, with no prior knowledge of C1 (100). Considering the example above, given the fact that L1/2 (120) oldName has a single instruction that is a call to newName, it would be perfectly safe to generate C2 (140) as follows:

```
void main ( ) {
  {
    int _result_01;
    _result_01 = newName(5);
    exit(_result_01);
  }
}
```

from the fragment:

```
{
  int _result_01;
  _result_01 = newName(<<parameter value>>);
  <<statement(_result_01)>>
}
```

(no risk on the parameter evaluation, since there is a single parameter, and the call to newName warranties that it is copied.)

Such refinements would be cataloged for a given embodiment of the invention, and applied as refinements of the standard generation process as described in the general flow chart of FIG. 2.

One other optional optimization of the result of the method of the general flow chart would be to optimize the code parametrized fragments substitution by modifying the code parametrized fragment expansion step (260) of the general flow chart. In some circumstances that depend on the contents of C1 (100), the substitution of the parametrized fragment can be optimized. For example, assuming that the code parametrized fragment optimization above is not implemented, it would still be safe to generate:

```
void main ( ) {
  {
    int _result_01;
    _result_01 = newName(5);
    exit(_result_01);
  }
}
```

because 5 is a literal that cannot be affected by double evaluation. The fact that it is a literal is only known when analyzing C1 (100), hence depends on the latter.

The invention could generate alternative parametrized fragments and select the most appropriate depending on the calling context in the client code.

Advanced code transformations can be performed also by applying the method described in the general flow chart of FIG. 2 to an extended API adapter input code. The exposed code transformations focus on the well-known case of function substitution. The invention can be leveraged to operate other transformations as well, including but not limited to:

types substitution; in objet-oriented languages, classes define types; those can be renamed (simplest case) or even linked by delegation patterns; subject to the fact that a class CL1 of L1 (110) can delegate all its implementation to a class CL2 of L2 (130), the invention has the potential to replace all references to CL1 in C1 (100) by references to CL2 in C2 (140);

coordinated transformations; some transformations cannot be done in isolation from others; for example, replacing a method by another one in one of the classes of a class hierarchy most often triggers the replacement of its specialization in inheriting classes; the invention has the potential to operate coordinated transformations in a single automated pass.

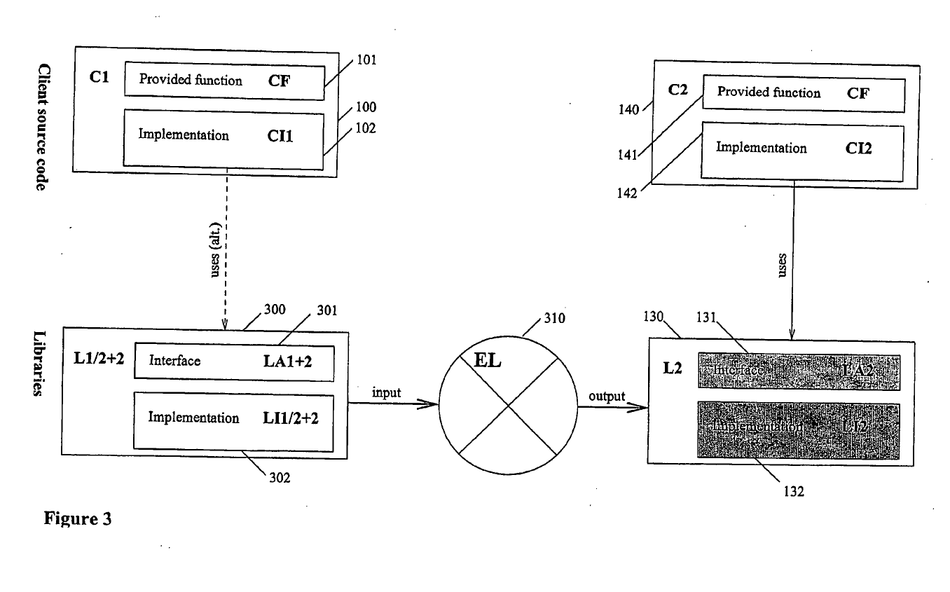

FIG. 3 illustrates the context of execution in Java like language of an additional engine, EL (310), which extracts the new API code from the new provider API libraries mixed into a same compilation unit with the API adapter libraries. In the case where the API code provider does not provide a separate code for the API adapter and the API code, the client once he will have transformed his old application code with the transformation engine into a new application code will use as the API layer code this mixed code layer delivered by the API provider. This is not satisfying as this API layer includes extra code not easy to maintain. The optional additional engine EL provides a new function of ‘cleaning’ the code delivered by the provider as it creates the API code wherein no more pieces of the API adapter is included. The steps of the execution of EL can then be added to the step of the general flow chart of the method as described in FIG. 2. The context illustrated in FIG. 3 shows the case in which L1/2 (120) and L2 (130) cannot be implemented into cleanly separated compilation units. This case is typical of the Java language, for example, where a renamed method of a given class must stay in the said class. A code example is given that, in the context of the Java programming language, shows the concrete results on the source code of a possible embodiment of the invention.

The L1 (110) library could consist into:

```
// L1 (110)
public class MyClass {
  public int oldName (int parameter) {
    // do something
  }
};
```

Since Java classes must be described in a single compiling unit, the only possible way to write an adapter library (like L1/2—120) is to keep both the new and the old methods in a single place:

```
// L1/2+2 (300)
public class MyClass {
  /**
  * @deprecated see newName
  * REPLACE
  */
  public int oldName (int parameter) {
    return newName(parameter);
  }
  public int newName (int parameter) {
    // do the same thing as oldName did in L1 (110)
  }
};
```

FIG. 3 gives the context for a separated source code transformation engine EL (310) that takes L1/2+2 (300) as its input and produces a ‘clean’ L2 (130) source code from which all references to LA1 (111) have been suppressed.

```
// L2 (130)
public class MyClass {
  public int newName (int parameter) {
    // do the same thing as oldName did in L1 (110)
  }
};
```

The flow chart of the additional steps to perform the function of the new engine EL (310) would be:

parsing EL1/2+2 (300) into an in memory representation similar to the one produced in step 1.1 (200) by E (150);

indexing replacement items like E (150) does in step 1.2 (210);

pruning all the indexed items from the in memory representation;

writing L2 (130) following the same method as E (150) uses in step 3 (270) to write C2 (140).

An optional use of the transformation engine (E 150) is to use E (150) to simplify the elaboration of L1/2 by applying E (150) to a version of LI1/2 (122) that references LA1 (121), seen as client code input. It may be more natural to describe selected parts of LI1/2 (122) in terms of LA1 (121) than in terms of LA2 (131). In particular, a verbatim copy of LI1 (112) is sometimes a good starting point to build parts of the code of LI1/2 (122). In such case, provided that this does not yield an infinite recursion or a conflict, the application of E (150—or a specialized E) to LI1/2 (122) would then produce a conforming L1/2 (120—that is an L1/2 that fulfills the requirements expressed for it in FIG. 1, namely that it only depends on L2 for its implementation).

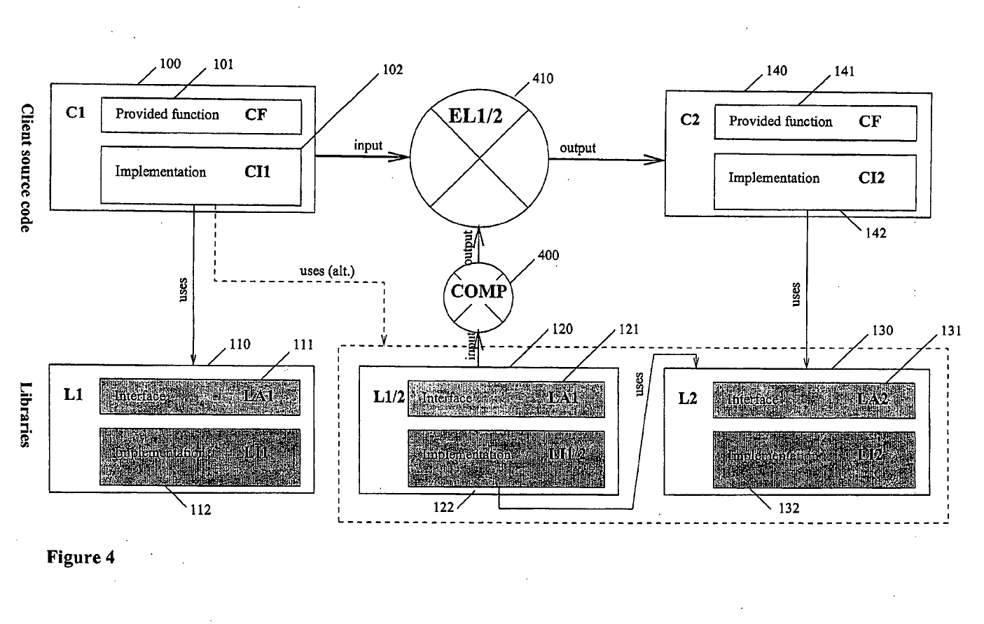

FIG. 4 illustrates the context of execution of another embodiment of the invention when the provider delivers an API adapter in binary code instead of source code. If the libraries provider is reluctant to provide his clients with L1/2 (120) source code, the additional steps can be performed:

transform L1/2 (120) into a binary representation that is not human readable but is suitable for use by a modified E (150);

produce a modified code transformation engine EL1/2 (410) that is compiled from L1/2 (120); note that the resulting transformation engine is then specialized for the specific (L1, L2) pair of libraries (whereas E is generic and takes L1/2 as its parameter).

FIG. 4 illustrates the second alternative, in which the COMP compiler (400) produces a dedicated EL1/2 transformation engine (410) that only takes C1 (100) as input. In such a case, L1/2 (120) would be consumed in its source form by COMP (400), but provided to client programmers in such a form that LA1 (121) would be human readable but potentially not in source code form, and LI1/2 (122) would be in binary form. The flow chart of the method implemented as the engine EL1/2 (410) comprises the same steps as the general flow chart of the engine E(150) of FIG. 2 except for first step 200 parsing L1/2 source code which is replaced by the step loading the binary code resulting from the compilation of the API adapter code.

1-10. (canceled)

11. A method of automatic reengineering of an input client code using an API when an API adapter code is provided for emulating an old version of the API on a new version of the API, wherein items no longer provided in the new API are identified, said method comprising the steps of:
generating a memory representation of an API adapter code;
building an index of the items of the API adapter code memory representation of which new API items have been identified;
generating a parametrized code memory representation of replacement code for the calls to the identified items;
parsing the input client code into a memory representation of the input client code;
searching to locate in the memory representation of the input client code for calls of which new API items have been identified and reading corresponding call parameters;
replacing the located calls by the parametrized code memory representation of replacement code including the corresponding call parameters read while searching for the calls; and
generating code corresponding to the memory representation of the input client code wherein the calls have been replaced.

12. The method of claim 11, wherein the generating a memory representation of an API adapter code comprises the steps of:
compiling API adapter source code into a binary representation of the API adapter code; and
loading the binary representation of the API adapter code into the memory representation of the API adapter code.

13. The method of claim 11, wherein the generating a memory representation of an API adapter code comprises the step of:
parsing API adapter source code into a memory representation of the API adapter code.

14. The method of claim 11, wherein the memory representation of an API adapter code or a memory representation of the input client code is an abstract syntax tree, an item is a tree node, and a symbol table is used for indexed items.

15. The method of claim 11, wherein the memory representation of the API adapter code or a memory representation of the input client code is a table, an item is a table record, and a symbol table is used for indexed items.

16. The method claim 11, wherein in the memory representation of API adapter code or a memory representation of the input client code is an acyclic directed graph, a item is a node in the graph, and a symbol table is used for indexed items.

17. The method of claim 11, wherein input client code, generated code, and API adapter source code, are written in the same programming language.

18. The method of claim 17, wherein said same programming language is Java or C or C++ or Pascal.

19. A computer program product comprising programming code instructions for executing the steps of the method of automatic reengineering of an input client code using an API when an API adapter code is provided for emulating an old version of the API on a new version of the API, wherein items no longer provided in the new API are identified, when said program is executed on a computer, said computer program product comprising:
computer program instructions for generating a memory representation of an API adapter code;
computer program instructions for building an index of the items of the API adapter code memory representation of which new API items have been identified;
computer program instructions for generating a parametrized code memory representation of replacement code for the calls to the identified items;
computer program instructions for parsing the input client code into a memory representation of the input client code;
computer program instructions for searching to locate in the memory representation of the input client code for calls of which new API items have been identified and reading corresponding call parameters;
computer program instructions for replacing the located calls by the parametrized code memory representation of replacement code including the corresponding call parameters read while searching for the calls; and
computer program instructions for generating code corresponding to the memory representation of the input client code wherein the calls have been replaced.

20. A system comprising means adapted for carrying out the method of automatic reengineering of an input client code using an API when an API adapter code is provided for emulating an old version of the API on a new version of the API, wherein items no longer provided in new API are identified, said means comprising:
means for generating a memory representation of an API adapter code;
means for building an index of the items of the API adapter code memory representation of which new API items have been identified;
means for generating a parametrized code memory representation of replacement code for the calls to the identified items;
means for parsing the input client code into a memory representation of the input client code;
means for searching to locate in the memory representation of the input client code for calls of which new API items have been identified and reading corresponding call parameters;
means for replacing the located calls by the parametrized code memory representation of replacement code including the corresponding call parameters read while searching for the calls; and
means for generating code corresponding to the memory representation of the input client code wherein the calls have been replaced.

21. The system of claim 20, wherein the generating a memory representation of an API adapter code comprises:
means for compiling API adapter source code into a binary representation of the API adapter code; and
means for loading the binary representation of the API adapter code into the memory representation of the API adapter code.

22. The system of claim 20, wherein the generating a memory representation of an API adapter code comprises:
means for parsing API adapter source code into a memory representation of the API adapter code.

23. The system of claim 20, wherein a memory representation of an API adapter code is an abstract syntax tree, an item is a tree node, and a symbol table is used for indexed items.

24. The system of claim 20, wherein a memory representation of an API adapter code or a memory representation of the input client code is a table, an item is a table record, and a symbol table is used for indexed items.

25. The system of claim 20, wherein in a memory representation of an API adapter code or a memory representation of the input client code is an acyclic directed graph, a item is a node in the graph, and a symbol table is used for indexed items.

26. The system of claim 20, wherein the input client code, the generated code, and the API adapter source code, are written in the same programming language.

27. The system of claim 26, wherein said programming language is Java or C or C++ or Pascal.
